(19) United States
(12) Patent Application Publication
(10) Pub. No.: US 2026/0191154 A1
(43) Pub. Date: Jul. 9, 2026

(54) APPARATUS AND PROCESS FOR LAYING TURF

(71) Applicant: TENAX S.p.A., VIGANO' (LC) (IT)

(72) Inventor: Cesare BERETTA, Engelberg (CH)

(21) Appl. No.: 19/443,783

(22) Filed: Jan. 8, 2026

(30) Foreign Application Priority Data
Jan. 9, 2025 (IT) 102025000000252

(51) Int. Cl. A01G 20/18

(52) U.S. Cl. CPC A01G 20/18

(57) ABSTRACT

A method of laying turf (G) by unwinding a roll (R) including a soil layer (S) and a reticular structure (2) wound around an axis (X) to define a respective plurality of windings. The method includes unwinding the roll (R) onto the ground and at least during the step of unwinding the roll removing at least part of the reticular structure (2).

### RELATED APPLICATION

This application incorporates by reference and claims priority to Italian patent application 102025000000252, filed January 9, 2025.

### FIELD OF THE INVENTION

The present invention relates to an apparatus and to a process for laying turf, for example for the creation of residential gardens, public areas, sports fields (for example, soccer fields and golf courses), commercial areas, or lawns for temporary events, such as fairs and exhibitions.

### BACKGROUND

The laying of turf by means of rolls of grass is a well-established technique used for the quick and uniform installation of lawns. This method is particularly appreciated for its capability to provide an immediately usable, high-quality grassed area. The turf laying process comprises a starting step of soil preparation, which provides for the removal of existing vegetation and a step of leveling and, if necessary, fertilization; afterwards, it is provided the laying of the turf, which essentially provides for unrolling the turf rolls onto the prepared ground. After laying, known steps of rolling and watering are carried out to allow the growth of the turf.

Unwinding the rolls, given the low resistance of the sod, may cause them to break; consequently, the operator is required to stop the process for manually carrying out the positioning of sod.

To reduce the possibility of grass sod (strip) breakage, it is known to realize turf rolls with integrated reinforcing geogrid made of biodegradable material capable of providing soil consolidation for a predetermined period of time before changing its chemical nature and be absorbed by the soil. In particular, are known biodegradable consolidation nets made of polylactic acid (PLA), polybutylene succinate (PBS) and polylactic acid (PLA) mixtures. For example, in the PCT patent application WO 2020/252233A1 have been described nets of biodegradable material made by means of a mixture of PBS, PLA and a degrading additive; these nets are used for sod cultivation. Biodegradable nets thus allow to reinforce the turf without negatively impacting environmental pollution. However, the Applicant has noted how biodegradable nets are complex to realize as well as highly expensive. The Applicant also has noted how the reinforcement of the turf using biodegradable geogrids requires additional steps of laying the nets before the step of planting the soil.

Alternatively, to prevent sod breakage, it is also known to make turf rolls wrapped with reinforcing, mono-oriented or bi-oriented nets made of high-density polymers. Such nets can be made by means of stretching (mono-directional or bi-directional) a starting semifinished product consisting of a uni-planar sheet of constant thickness extruded and then drilled as described in the following patent patents and published applications: US 5,419,659A, US 2004/062615A1, US 3,386,876, US 7,407,699B2, US 6,423,394B1. Alternatively, such nets can be realized by extruding a series of first and second elements joined together to define a monolithic grid. The extruded grid is then stretched along one or more directions to define a single-stretched or bi-stretched reticular structure as described in US Patents 4,662,946A and US 5,753,337A.

The nets are applied to a bottom surface of the turf during the roll winding step.

These nets result chemically inert and have an excellent tensile strength in the direction of the stretched elements: the nets are capable of absorbing the stresses and redistributing them evenly in the soil, thereby ultimately ensuring greater static and dynamic strength of the entire reinforced structure.

During the process of installation of the turf the nets, as in the case of biodegradable nets, are kept below the sod. Although the above-mentioned known nets are widely used, the Applicant has noted that such known nets are not free from limitations and drawbacks. Indeed, the known nets are made by means of non-biodegradable polymers; the nets thus constituted are configured to keep their chemical nature unchanged over time and thus not to be absorbed by the soil with consequent negative environmental impact: such materials are in fact considered pollutants.

The Applicant has therefore noted how the above-described state-of-the-art solutions are improvable in certain aspects.

### SUMMARY

The present invention may be applied to substantially solve at least one of the drawbacks and/or limitations of the preceding solutions.

The present invention may make available a simple and quick turf installation process that can, at the same time, prevent the turf from breaking during the installation steps. The present invention may be embodied as a low-cost turf installation process that can also prevent the pollution of the environment.

The invention may be applied to make available a simple and compact equipment, capable of carrying out the installation process according to the present invention. The invention may be embodied as a turf laying equipment capable of carrying out the installation of the turf, avoiding its breakage.

In an aspect, the invention may be embodied as a turf laying process (G) by unwinding a roll (R) of the type comprising at least one soil layer (S) extending in thickness between a first and a second surface (S2), wherein the soil layer (S) has grass (E) emerging from the second surface (S2), wherein the soil layer (S) is wound in a roll around an axis (X) between an inner longitudinal flap (S') and an outer longitudinal flap (S'') to define a plurality of windings, wherein the grass (E) of the soil layer (S) is substantially facing said axis (X), wherein said roll (R) further comprises a reticular structure (2) also wound around the axis (X) between an inner longitudinal flap (2') and an outer longitudinal flap (2'') defining a respective plurality of windings at least partly interposed between the windings of the soil layer (S),

wherein the process comprises the following steps:

unwinding the roll (R) on the ground in such a way that the first surface (S1) of the soil layer (S) is in contact with the ground (T),

at least during the unwinding phase of the roll, removing at least part of the reticular structure.

In an aspect according to the preceding aspect, the step of unwinding the roll (R) comprises at least the following sub-steps:

place the roll (R) on the ground (T),

lay at least one tract of the soil layer (S) to the ground (T) comprising the outer longitudinal flap (S'') of said soil layer (S),

move at least part of the roll (R) along an advancement direction (A) to unwind said roll (R) in such a way as to distance the outer longitudinal flap (S') of the soil layer (S) from the inner longitudinal flap (S') of the same soil layer (S).

In an aspect according to any one of the two preceding aspects the step of unwinding the roll takes place around the axis (X) of the soil layer (S) and of the reticular structure (2). In an aspect according to any one of the preceding aspects the axis (X) during the step of unwinding the roll (R) moves along the advancement direction (A) and approaching the ground (T).

In an aspect according to any one of the preceding aspects the inner terminal flap (S’) of the soil layer, at least during the step of unwinding the roll (R) moves away from the outer terminal flap (S'') of the same soil layer (optionally placed on the ground). In an aspect according to any one of the preceding aspects the outer terminal flap (S'') of the soil layer (S), during the unwinding of the roll (R) is substantially fixed to the ground.

In an aspect according to any one of the preceding aspects the soil layer (S), at least in a fully wound condition of the roll (R), has at least an outer winding. In an aspect according to the preceding aspect the outer winding of the soil layer (S) defines substantially at least part of an outer surface of the roll (R). In an aspect according to any one of the two preceding aspects the outer winding of the soil layer (S) extends starting from the outer terminal flap (S’’) until at a tract wound until at the outer terminal flap (S”) of the soil layer itself.

In an aspect according to any one of the three preceding aspects the step of unwinding the roll comprises a step of initial unwinding that comprises the following sub-steps:

unwind at least a part of the outer winding of the roll (R) in such a way that the outer longitudinal flap (S'') of the soil layer (S) is laid on the ground,

contact at least a part of an outer winding of the reticular structure (2);

move said roll (R) along the advancement direction (A) to allow an unwinding of the soil layer (S) on the ground and of the reticular structure (2),

at least during the step of moving the roll (R), remove the reticular structure (2) unwinding from the roll (R).

In an aspect according to any one of the preceding aspects, the step of taking out the reticular structure (2), optionally at least during the step of unwinding the roll (R), comprises a step of winding the reticular structure around a respective collecting axis (Y). In an aspect according to the preceding aspect the collecting axis (Y) is distinct and distanced from the axis (X) of the roll (R). In an aspect according to any one of the two preceding aspects the collecting axis (Y) of the reticular structure (2) is arranged upwards of the axis (X) with respect to the advancement direction (A). In an aspect according to anyone of the three preceding aspect the collecting axis (Y) is movable with respect to the axis (X) of the roll (R). In an aspect according to anyone of the four preceding aspect the collecting axis (Y) is movable approaching and moving away with respect to the axis (X) of the roll (R). In an aspect according to anyone of the five preceding aspect the collecting axis (Y) is substantially parallel to the axis (X) of the roll (R).

In an aspect according to any one of the six preceding aspects the step of winding the reticular structure (2) around the collecting axis (Y) comprises a winding of the reticular structure (2) around a drum, optionally motorized.

In an aspect according to any one of the preceding aspects the reticular structure (2), at least in a completely wound condition of the roll (R), comprises an outer winding that entirely covers the outer winding of the soil layer (S). In an aspect according to any one of the preceding aspects the outer terminal

flap (2”) of the reticular structure (2), at least in a completely wound condition of the roll (R), is distanced from the outer terminal flap (S”) of the soil layer (S). In an aspect according to any one of the preceding aspects the outer terminal flap (2”) of the reticular structure (2), at least in a completely wound condition of the roll (R), extends beyond the outer terminal flap (S”) of the soil layer (S), with respect to a winding direction of the roll around the axis (X)..

In an aspect according to any one of the three preceding aspects, the process comprises a cutting step of the outer winding and the immediately underlying winding of the reticular structure (2) at a tract located between the outer terminal flap (S'') of the soil layer (S) and the outer terminal flap (2'') of the reticular structure (2), wherein said cutting step of the reticular structure (2) defines:

on the outer winding, an intermediate longitudinal flap (2'') arranged between the outer terminal flap (S'') of the soil layer (S) and the outer terminal flap (2'') of the reticular structure (2), wherein the outer winding of the reticular structure (2), following the cutting step, has a first sector (2a) comprising the outer terminal flap (2'') and a second sector (2b) comprising the intermediate flap (2''),

on the winding of the reticular structure (2) immediately underlying the outer winding, a terminal gripping flap (2c').

In an aspect according to the preceding aspect, after the cutting step, comprises the following steps:

lay at least one tract of the soil layer (S) on the ground (T) comprising the outer terminal flap (S'') of the soil layer (S) together with the second sector (2b) of the outer winding of the reticular structure (2), optionally interposed between the soil (T) and said soil layer (S) laid on the ground,

optionally remove the outer winding of the reticular structure (2).

In an aspect according to the preceding aspect, the process comprises the process, after the cutting step, comprises the following steps:

grasp the reticular structure at the terminal gripping flap (2c'),

following the step of grasping the reticular structure at the terminal gripping flap, move the roll along the advancement direction to unwind the soil layer on the ground and unwind the reticular structure,

during the step of unwinding the soil layer and reticular structure, withdraw the reticular structure.

In an aspect according to the preceding aspect the step of grasping the reticular structure (2) comprises at least a step of engaging said one winding drum structure, at the terminal gripping flap (2c'). In an aspect according to any one of the two preceding aspects the step of taking out the reticular structure (2) comprises a step of winding said reticular structure (2) around a collecting axis (Y), optionally around the drum. In an aspect according to the preceding aspect the reticular structure (2) is wound around the collecting axis (Y), starting from a tract placed at the terminal gripping flap (2c').

In an aspect according to any one of the preceding aspects the cutting of the reticular structure (2) is carried out along the entire width of the reticular structure, optionally said width is defined along the axis (X) of the roll (R).

In an aspect according to any one of the preceding aspects the roll (R), before the step of unwinding, has a leaning zone (8) facing the ground (optionally in contact with the ground) wherein the outer terminal flap (S'') of the soil layer (S), before the step of unwinding of the roll, is distanced from said leaning area (8). In an aspect according to the preceding aspect the outer terminal flap (S'') of the soil layer (S), before the step of unwinding of the roll, is substantially counterposed to the leaning area (8).

In an aspect according to any one of the preceding aspects the outer terminal flap (S'') of the soil layer (S), before the step of cutting the reticular structure, is distanced from (optionally substantially counterposed to) the leaning area (8).

In an aspect according to any one of the preceding aspects the roll (R), before the step of laying at least a soil layer (S) comprises a step of leaning the roll to the ground at the leaning area (8). In an aspect according to the preceding aspect, after the leaning of the roll on the ground, comprises the steps of:

lay the at least one tract of the soil layer (S) to the ground (T) comprising the outer longitudinal flap (S''),

remove the outer winding of the reticular structure (2),

grasp the reticular structure at the terminal gripping flap (2c'),

following the step of gripping the reticular structure at the terminal gripping flap, move the roll along the advancement direction to unwind the soil layer on the ground and unwind the reticular structure,

during the step of unwinding the soil layer and reticular structure, remove the reticular structure.

In an aspect according to any one of the preceding aspects the step of taking out the reticular structure (2) is synchronized with the step of unwinding of the soil layer (S). In an aspect according to any one of the preceding aspects the step of winding the reticular structure (2) is synchronized with the step of unwinding the soil layer (S). In an aspect according to any one of the preceding aspects the winding speed of the reticular structure (2) is proportional to at least one of the following parameters: a speed of movement of the roll along the advancement direction, an angular speed of a point of the unwinding roll.

In an aspect according to any one of the preceding aspects the roll (R) has an outer diameter greater than 50 cm, optionally between 60 cm and 200 cm, even more optionally between 70 cm and 150 cm. In an aspect according to according to any one of the preceding aspects the outer winding of the soil layer (S) defines substantially the outer diameter of the roll (R). In an aspect according to any one of the preceding aspects the diameter of the roll (R) is essentially defined by the diameter of the outer lateral surface of the soil layer.

In an aspect according to any one of the preceding aspects the roll (R) extends along the axis (X) between a first and a second head portion. In an aspect according to the preceding aspect the distance present between the first and the second head portion defines substantially a width of the roll (R). In an aspect according to any one of the two preceding aspects the distance between the first and the second head portion is greater than 0.25 m, optionally between 0.3 m and 1.8 m, even more optionally between 0.3 m and 1.5 m.

In an aspect according to any one of the preceding aspects the soil layer has a prefixed width measured along the axis (X) of the roll. In an aspect according to the preceding aspect the width of the soil layer is greater than 0.25 m, optionally between 0.3 m and 1.8 m, even more optionally between 0.3 m and 1.5 m. In an aspect according to any one of the preceding aspects the reticular structure (2) has a prefixed width measured along the axis (X) of the roll. In an aspect according to the preceding aspect the width of the reticular structure (2) is greater than 0.25 m, optionally between 0.3 m and 1.8 m, even more optionally between 0.3 m and 1.5 m. In an aspect according to any one of the preceding aspects the width of the reticular structure (2) is substantially equal to the width of the soil layer (S).

In an aspect according to any one of the preceding aspects the soil layer (S) has a length measured along its own windings greater than 20 m, optionally between 25 m and 50 m, even more optionally between 30 m and 45 m. In an aspect according to any one of the preceding aspects the lattice structure (2) has a measured length along its windings greater than 20 m, optionally between 25 m and 50 m, even more optionally between 30 m and 45 m. In an aspect according to any one of the preceding aspects, the length of the reticular structure (2) is substantially equal to or greater than to the length of the soil layer (S).

In an aspect according to any one of the preceding aspects the reticular structure (2) extends in thickness substantially between a lower surface and an upper surface. In an aspect according to the preceding aspect the thickness of the reticular structure (2) is lower than 3 mm, optionally between 0,1 e 1,5 mm.

In an aspect according to any one of the preceding aspects the reticular structure (2) comprises

a plurality of first elements (3) distanced from each other and having an elongated conformation according to a first trajectory (T1),

a plurality of second elements (4) distanced from each other and having an elongated conformation according to a second trajectory (T2) transversal to the first trajectory (T1),

wherein said first and second elements (3, 4) intersect at knots (5) to form meshes (6).

In an aspect according to any one of the preceding aspects the first elements (3) extend along the plurality of windings of the reticular structure (2). In an aspect according to any one of the preceding aspects each first element (3) extends in length along the full length extension of the reticular structure (2), optionally said length extension is measured along the windings, even more optionally along a plane orthogonal to the axis (X) of the reticular structure. In an aspect according to any one of the preceding aspects the length of each first element (3) coincides substantially with the length of the reticular structure (2). In an aspect according to any one of the preceding aspects each first element (3) extends in length between the inner terminal flap (2’) and the outer terminal flap (2”) of the reticular structure (2). In an aspect according to any one of the preceding aspects the first elements (3) of the reticular structure are distanced to each other with respect to a direction parallel to the axis (X) of the roll. In an aspect according to the preceding aspect the distance between the two first elements immediately consecutive with respect to the axis (X) is between 15 and 70 mm, optionally between 20 and 50 mm. In an aspect according to any one of the preceding aspects each first element (3) extends along the plurality of windings of the reticular structure (2). In an aspect according to any one of the preceding aspects the first elements (3) have a length greater than 20 m, optionally between 25 m and 50 m, even more optionally between 30 m and 45 m.

In an aspect according to any one of the preceding aspects the first elements (3) are stretched along their development, wherein the stretching ratio of a first element (3) is defined as the ratio between a final length of the same first element once the stretching is carried out and the initial length of such first element before the stretching action. In an aspect according to any one of the preceding aspects the first elements (3) have a stretching ratio greater than 1.5, optionally between 2 and 8, more optionally between 2.5 and 4, the stretching ratio between the first elements (3) is defined as the ratio between a final length of the first elements after a stretching action of the elements and an initial length of the first elements before the stretching.

In an aspect according to any one of the preceding aspects the first elements (3) have a substantially threadlike structure. In an aspect according to any one of the preceding aspects said first elements (3) have a transversal section, measured at a centerline portion defined between two immediately consecutive knots, of area less than 5 mm², optionally between 0.1 mm² and 1.5 mm².

In an aspect according to any one of the preceding aspects the second trajectory (T2) of the second elements (4), at least in the fully wound roll condition, is substantially parallel to the axis (X). In an aspect according to any one of the preceding aspects the second elements (4) are parallel to each other, optionally the second development trajectories (T2) of the second elements are parallel to each other. In an aspect according to any one of the preceding aspects the trajectories (T2) of the second elements (4) are substantially rectilinear. In an aspect according to any one of the preceding aspects the second trajectory (T2) of each second element (4) is substantially orthogonal with respect to the first trajectory (T1) of the first elements (3).

In an aspect according to any one of the preceding aspects each second element (4) extends between the first and the second head portion of the roll (R). In an aspect according to any one of the preceding aspects the length of each second element (4) coincides substantially with the length of the roll (R). In an aspect according to any one of the preceding aspects each second element (4) has a length greater than 0.25 m, optionally between 0.3 m and 1.8 m, even more optionally between 0.3 m and 1.5 m. In an aspect according to any of the preceding aspects the second elements (4) are distanced from each other. In an aspect according to any one of the preceding aspects two second elements (4) immediately consecutive along the windings are placed at a minimum distance between 12 and 50 mm, optionally between 15 and 40 mm.

In an aspect according to any one of the preceding aspects the second elements (4) are stretched along their development, wherein the stretching ratio of a second element (4) is defined as the ratio between a final length of the same second element (4) once the stretching is carried out and the initial length of such second element before the stretching action.

In an aspect according to any one of the preceding aspects the second elements (4) have a stretching ratio greater than 1.5, optionally between 2 and 5, more optionally between 2 and 4, the stretching ratio of the second elements (4) being defined as the ratio between a final length of the second elements after a stretching action of them and an initial length of the second elements before the stretching.

In an aspect according to any one of the preceding aspects the second elements (4) have a substantially threadlike structure. In an aspect according to any one of the preceding aspects said second elements (4) have a transversal section, measured at a centerline portion defined between two immediately consecutive knots, of area less than 5 mm², optionally between 0.1 mm² and 1.5 mm².

In an aspect according to any one of the preceding aspects the ratio between the distance between the two adjacent first elements (3) and the distance between two adjacent second elements (4) is between 0.5 and 2, optionally between 0.5 and 1.8.

In an aspect according to any one of the preceding aspects the first elements (3) are substantially identical to the second elements (4). In an aspect according to any one of the preceding aspects the first elements (3) are identical in form to the second elements (4). In an aspect according to any one of the preceding aspects the first elements are identical in size to the second elements.

In an aspect according to any one of the preceding aspects the reticular structure (2) comprises meshes (6) having a quadrilateral shape, optionally having a substantially square or rectangular shape. In an aspect according to any one of the preceding aspects the size of each mesh (6) is defined by the distance of the two immediately consecutive first elements which intersect at said two immediately consecutive first elements.

In an aspect according to any one of the preceding aspects the first elements (3) and/or second elements (4) have a full transversal section. In an aspect according to any one of the preceding aspects the ratio between a transversal area of a first element (3), measured at an intermediate portion between two immediately consecutive knots (5), and a transversal area of a second element (4), also measured at an intermediate portion between two immediately consecutive knots (5), is between 0.5 and 2, optionally between 0.7 and 1.2.

In an aspect according to any one of the preceding aspects the reticular structure has a weight between 5 g/m² and 15 g/m², optionally between 6 g/m² and 12 g/m².

In an aspect according to any one of the preceding aspects the reticular structure (2) has a specific tensile resistance along the development path of the first and/or second elements (3, 4) equal to or greater than 0.3 kN/m, in particular between 0.5 kN/m and 5 kN/m, optionally between 1 kN/m and 2 kN/m; said specific tensile resistance being measured using the method given in ASTM D7179. In an aspect according to any one of the preceding aspects the reticular structure (2) has a specific tensile resistance along the development path of the first elements (3, 4) equal to or greater than 0.8 kN/m, in particular between 0.1 kN/m and 2 kN/m, optionally between 1.1 kN/m and 1.5 kN/m; said specific tensile resistance being measured using the method given in ASTM D7179.

In an aspect according to the preceding aspect the reticular structure (2) is configured to reinforce the soil layer (S), optionally to allow the laying of the soil layer on the ground by preventing it from breaking. In an aspect according to any one of the preceding aspects the reticular structure (2) is monolithic. In an aspect according to any one of the preceding aspects the reticular structure (2) is made at least partly of plastic material. In an aspect according to any one of the preceding aspects the reticular structure (2) is made (optionally entirely) in at least one of the following materials: polypropylene, polyethylene, polyester, or a mixture of two or more of said materials.

In an aspect according to any one of the preceding aspects the first and second elements (3, 4) are obtained by stretching a semi-finished product with a reticular structure having first and second precursor elements intersecting at knots to define the meshes. In an aspect according to the preceding aspect the semi-finished product with a reticular structure is obtained through:

an extrusion process, or

extrusion of a solid sheet subsequently cut.

In an aspect according to the two preceding aspects the semi-finished product with a reticular structure (2) is obtained through an extrusion process with pulsating technology. In an aspect according to any one of the preceding aspects the reticular structure (2) is obtained through an extrusion process with pulsating technology.

In an aspect according to any one of the preceding aspects the soil layer (S) extends in thickness between the first and the second surface (S1, S2). In an aspect according to the preceding aspect the width of the soil layer is greater than 0.5 cm, optionally is between 0.65 cm and 20 cm, even more optionally between 5 cm and 15 cm. In an aspect according to any one of the preceding aspects the reticular structure (2), in the fully wound condition, is at least in contact with the first surface of the soil layer (S). In an aspect according to any one of the preceding aspects the reticular structure of the outer winding is in contact uniquely with the first surface (S1) of the outer winding of the soil layer (S).

In an aspect according to any one of the preceding aspects the soil layer (S) of the roll, fully unwound and laid on a plane, has a length between 20 m, optionally between 25 m and 50 m, even more optionally between 30 m and 45 m; said length being measured along one direction of unwinding of the same roll.

In an aspect according to any one of the preceding aspects the roll (1) comprises an inner winding that delimits a seat (9). In an aspect according to the preceding aspect the seat (9) extends along the axis (X) of the roll. In an aspect according to any one of the two preceding aspects the seat (9) extends for the entire extension of the roll (R) along said axis (X). In an aspect according to any one of the three preceding aspects the soil layer (S) comprises an inner winding that delimits an inner lateral surface of the roll (R) that delimits said seat (9). In an aspect according to the preceding aspect the inner lateral surface of the roll (R) has a diameter between 50 mm and 250 mm, optionally between 60 and 220 mm.

In an aspect according to any one of the four preceding aspects the seat (9) is configured to receive a roll around which is wound the soil layer (S) and the reticular structure (2).

In an aspect is provided a turf laying equipment (10), said equipment (10) comprising:

a frame (11),

a movement system (12) that supports the frame (11) and configured to allow the movement of the equipment (10),

a support (13) carried by the frame (11), wherein said support (13) is configured to support at least a roll (R) comprising at least a soil layer and a reticular structure wrapped around an axis (X), wherein said support (13) is configured to allow the unwinding of the roll to the ground (S).

In an aspect according to the preceding aspect the equipment (10) comprises a collection device (14) configured to pick up the reticular structure, at least during the unwinding of the roll (R) to the ground (S).

In an aspect according to any one of the preceding aspects the movement system (12) comprises at least one of: an axle carrying one or more wheels, a track system, at least one roller. In an aspect according to any one of the preceding aspects the frame (11) is constrained to the movement system (12) configured to allow the movement of the equipment on the ground (T), optionally along an advancement direction (A).

In an aspect according to any one of the preceding aspects the equipment (10) comprises a guiding system carried by the frame (11) and connected to the movement system (12), where the guiding system is configured to allow a user to maneuver the equipment (10). In an aspect according to the preceding aspect the guiding system comprises a motor, a transmission system that connects the motor to the movement system (12), a maneuvering system connected to the motor and the transmission system, where said maneuvering system being configured to allow a user to drive in the movement the equipment (10). In an aspect according to any one of the two preceding aspects the frame (11) comprises a driver's seat (18) configured to receive at least one user.

In an aspect according to any one of the preceding aspects the support (13), in use, is configured to move the roll (R) approaching and moving away with respect to the soil. In an aspect according to any one of the preceding aspects the support (13), in use, is configured to allow the movement of the roll (R) along at least a vertical direction. In an aspect according to any one of the preceding aspects the support (13), in use, is configured to lift and lower the roll (R).

In an aspect according to any one of the preceding aspects the roll (13) comprises at least an arm constrained to the frame (11). In an aspect according to the preceding aspect the support (13), optionally the arm, extends longitudinally between a first and second end portions (13a, 13b), wherein said support (13), optionally said arm, is engaged to the frame (11) at the first end portion (13a). In an aspect according to any one of the two preceding aspects the support (13), optionally said at least an arm, is hinged to the frame, optionally at the first end portion (13a).

In an aspect according to any one of the preceding aspects the support (13) comprises a engagement portion configured to receive in engagement at least one roll (R). In an aspect according to the preceding aspect the engagement portion is defined at the second end portion (13b) of the support. In an aspect according to any one of the two preceding aspects the engagement portion comprises at least a roll configured to be inserted at least partially into the roll. In an aspect according to the preceding aspect the roll is configured to rotate around its own axis to allow the rotation of the roll (R) engaged to said roll. In an aspect according to the preceding aspect the axis of the roll of the engagement portion, in use, is substantially horizontal. In an aspect according to any one of the two preceding aspects the axis of the roll of the engagement portion is configured to result substantially parallel to the axis (X) of the roll when engaged to the roll.

In an aspect according to any one of the preceding aspects the engagement portion, optionally the roll, is configured to be inserted in the seat (9) of the roll (R). In an aspect according to any one of the preceding aspects the roll of the engagement portion is configured to allow the rotation of the roll (R) to allow the unwinding to the ground.

In an aspect according to any one of the preceding aspects the engagement portion of the support (13) is movable approaching and moving away with respect to the frame (11). In an aspect according to any one of the preceding aspects the engagement portion is configured to

rotate around its own axis, optionally to allow the rotation of the roll around the axis (X), and

rotate around an axis arranged substantially at the frame (11) to allow the engagement portion to move in approach and moving away with respect to the ground (T).

In an aspect according to any one of the preceding aspects the at least a support arm (13) is of an extendable type, optionally to vary a distance between the first and second end portions (13a, 13b). In an aspect according to any one of the preceding aspects the at least an arm comprises at least a first and second arm distanced from each other. In an aspect according to the preceding aspect the first and second arm are configured to engage the roll of the engagement portion at the second end portion.

In an aspect according to any one of the preceding aspects the first and second arm are distanced from each other and configured to receive in interposition at least one roll (R).

In an aspect according to any one of the preceding aspects the collection device (14) is engaged to at least one between the frame (11) and the support (13). In an aspect according to any one of the preceding aspects the collection device (14) is configured to wind the reticular structure (2) around a collecting axis (Y). In an aspect according to the preceding aspect the collecting axis (Y) is, in use, horizontal. In an aspect according to any one of the two preceding aspects the collecting axis (Y) is substantially parallel to the axis around which is movable the roll of the engagement portion of the support (13). In an aspect according to anyone of the three preceding aspect the collecting axis (Y) is configured to result substantially parallel to the axis (X) of the roll (R) carried by the support (13).

In an aspect according to any one of the preceding aspects the collection device (14) comprises at least one arm (15) constrained to at least one between the frame (11) and the support (13). In an aspect according to the preceding aspect the support (15), of the collection device (14), extends longitudinally between a first and second end portions (15a, 15b), wherein the arm (15) of the collection device (14) is engaged to the frame (11) and/or to the support (13) at the first end portion (15a). In an aspect according to any one of the two preceding aspects the arm (15), is hinged to the frame and/or to the support, optionally at the first end portion (15a).

In an aspect according to any one of the preceding aspects the collection device (14) comprises a respective engagement portion (16) configured to receive in engagement (optionally in winding) the reticular structure in winding from the roll (R). In an aspect according to the preceding aspect the engagement portion is defined at the second end portion (15b) of the arm (15) of the collection device (14). In an aspect according to any one of the two preceding aspects the engagement portion (16) of the collection device (14) comprises at least a drum. In an aspect according to the preceding aspect the drum is configured to rotate around its own axis, optionally to allow the winding of the reticular structure around the drum itself. In an aspect according to the preceding aspect the axis of the drum of the engagement portion (16) coincides with the collecting axis (Y). In an aspect according to any one of the two preceding aspects the axis of the drum of the engagement portion (16) is configured to result substantially parallel to the axis (X) of the roll when engaged to the roll.

In an aspect according to any one of the preceding aspects the engagement portion, optionally the roll is

Movable in approaching and moving away with respect to the frame (11). In an aspect according to any one of the preceding aspects the at least a support arm (14) is of an extendable type, optionally to vary a distance between the first and second end portions (15a, 15b). In an aspect according to any one of the preceding aspects the at least an arm (15) of the collection device (14) comprises at least a first and second arm distanced from each other. In an aspect according to the preceding aspect the first and second arm of the collection device (14) are configured to engage the drum of the engagement portion (16) at the second end portion (15b). In an aspect according to any one of the preceding aspects the first and second arm of the collection device (14) are distanced from each other and configured to receive in interposition the reticular structure (2).

In an aspect according to any one of the preceding aspects the support (13) is interposed between the frame (11) and the engagement portion (16) of the collection device (14). In an aspect according to any one of the preceding aspects the drum of the collection device, in use, is laid at a first distance from the ground, wherein the roll of the support (13) is laid at a second distance from the ground, wherein the first distance is greater than the first distance. In an aspect according to the preceding aspect wherein the ratio between the first distance and the second distance is higher than 1.2 optionally between 1.5 and 3.

In an aspect according to any one of the two preceding aspects the drum of the engagement portion (16) of the collection device (14) is of the motorized type. In an aspect according to any one of the preceding aspects the collection device (14) comprises at least an actuator active on the drum and configured to allow the rotation of the drum itself around its own axis, optionally the collecting axis (Y). In an aspect according to the preceding aspect the actuator comprises at least an electric motor active on the drum.

In an aspect according to any one of the preceding aspects the equipment comprises a control unit active in command on the actuator and configured to command a rotation of the drum of the collection device. In an aspect according to the preceding aspect the equipment (10) comprises at least a sensor connected to the control unit, said sensor being configured to emit a signal representative of at least a rotation parameter of the roll of the support (13), wherein said control unit being configured to:

receive at least one signal from the sensor,

in accordance with the received signal, estimate a value of the rotation parameter,

in accordance with the estimated value of the rotation parameter, command the activation of the actuator to determine a rotation of the drum of the collection device (14).

In an aspect according to the preceding aspect the control unit is configured to command the activation of the actuator to adjust the rotation speed of the drum in accordance with the estimated value of the rotation parameter of the roll. In an aspect according to any one of the two preceding aspects the rotation parameter comprises at least one of: an angular speed of the roll of the support, a rotation speed of the roll, a rotation speed of a point defined on the outer surface of a roll engaged to the roll.

In an aspect according to any one of the preceding aspects the control unit is configured to synchronize the rotation of the drum of the collection device (14) with a rotation of a roll (R) engaged to the roll, optionally unwinding around the roll of the support (13).

In an aspect according to any one of the preceding aspects the equipment (10) is configured to carry out the process in accordance with any one of the preceding aspects. In an aspect according to any one of the preceding aspects the equipment (10) is configured to carry out the laying process in accordance with any one of the preceding aspects for the unwinding of the roll (R) and the realization of the turf (G).

In an aspect is provided a use of the equipment (10) in accordance to any one of the preceding aspects for the realization of turf layers, optionally at least one of: residential gardens, public areas, sports fields, commercial areas, lawns for temporary events).

### SUMMARY OF DRAWINGS

Some embodiments and aspects of the invention will be described below with reference to the attached drawings, provided for illustrative purposes only and therefore in a non-limiting extent in which:

FIG. 1 shows a reticular structure;

FIG. 2 shows a roller in a fully wound condition, comprising a soil layer and a reticular structure; and

FIGS. 3 to 9 show schematically the steps of unwinding the roll of FIG. 2.

### DEFINITIONS AND CONVENTIONS

It is to be noted that in the present detailed description corresponding parts shown in the various figures are indicated by the same numerical references. Figures could show the object of the invention by means of representations that are not to scale; therefore, parts and components shown in figures related to the object of the invention could only relate to schematic representations.

The term “advancement direction” refers to a direction along which the roll is moved to allow the unwinding and thus the laying of the soil of a soil layer of said roll.

With the term “turf (G)” is intended a soil layer from which superficially emerges grass (E).

With the term “roll (R)” is intended at least a soil layer (S) and a reticular structure (2) wound around an axis (X) to define a plurality of windings. In particular, the soil layer (S) extends in thickness between a first and a second surface (S1, S2), wherein the soil layer (S) has grass (E) emerging from the second surface (S2). The soil layer (S), in a fully wound condition of the roll, is wound around the axis (X) between an inner terminal flap (S’) and an outer terminal flap (S”) to define a plurality of windings; the grass (E) of the soil layer (S) results substantially facing the axis (X).

The reticular structure (2) is too wound around the axis (X) between an inner longitudinal flap (2') and an outer longitudinal flap (2'') defining a respective plurality of windings at least partly interposed between the windings of the soil layer (S).

The axis (X) indicates the axis around which the roll (R) is wound. In particular, with axis (X) is intended also the axis around which the roll can be wound and unwound.

With the term ‘stretched’ in relation to first and/or second elements (3, 4) of the reticular structure (2) is intended a process that allows to elongate said elements in such a way as to arrange the molecular chains that form the latter (said first and/or second elements 3, 4) according to an orientation accentuatedly oriented along the prevailing development direction of the elements themselves. Depending on the degree of stretching, the elements may have a more or less subtle structure and may also assume substantially thread-like conformation. As will be better described later, stretching is carried out from a monolithic semi-finished product with a reticular structure having first precursor bodies substantially distanced from each other intersected with second precursor bodies also substantially distanced from each other: the first and second precursor bodies essentially form a net with square or rectangular meshes in which at least the first precursor bodies can, in a non-limiting extent, extend parallel to the extrusion direction. The stretching ratio is also defined as the ratio between a stretched element and the length of the relative precursor body capable of defining, as a result of the stretching action, said stretched element.

The equipment object of the present invention, optionally configured to carry out the described and claimed laying process, may comprise at least one control unit. The control unit is in charge of controlling operating conditions put in place by the same equipment. The control unit may be a single unit or be formed by a plurality of distinct control units depending on design choices and operational requirements.

With ‘control unit’ is intended an electronic type component, which may comprise at least one of: a digital processor (CPU), an analog type circuit, or a combination of one or more digital processors with one or more analog type circuits. The 'control unit can be “configured” or “programmed” to carry out certain steps: this can be realized practically with any means that allows to configure or program the control unit. For example, in case of a control unit comprising one or more CPUs and one or more memories, one or more programs may be stored in appropriate memory banks connected to the CPU(s); the program(s) contain instructions that, when executed by the CPU(s), program or configure the control unit to carry out the operations described in relation to the control unit. Alternatively, if the control unit is or comprises analog type circuitry, then the circuit of the control unit may be designed to include circuitry configured, in use, to process electrical signals in such a way as to carry out the steps related to the control unit.

Parts of the process described herein can be carried out by means of a data processing unit, or control unit, technically substitutable with one or more electronic processors conceived to carry out a portion of a software program or firmware loaded onto a memory support. Such software program may be written in any programming language of a known type. The electronic processors, if two or more in number, may be connected to each other by means of a data connection such that their computational powers are in any way shared; the same electronic processors may thus be installed in even geographically different locations, realizing through the aforementioned data connection a distributed computing environment.

The data processing unit, or control unit, can be a general purpose-type processor configured to carry out one or more parts of the process identified in the present disclosure through the software program or firmware, or be an ASIC or dedicated processor or FPGA, specifically programmed to carry out at least part of the operations of the process described herein.

The memory support may be non-transitory and may be internal or external to the processor, or control unit, or data processing unit, and may -specifically- be a memory geographically located remotely with respect to the electronic processor. The memory support may also be physically divided into multiple portions, or in cloud form, and the software or firmware program may provide for portions stored on memory portions geographically divided from each other.

### DETAILED DESCRIPTION

### Roll

With R has been indicated a roll wound around an axis X according to a spiral pattern and comprising a soil layer S, a predetermined amount of grass G emerging from a side of the soil layer S and at least a reticular structure 2 engaged to the soil layer S.

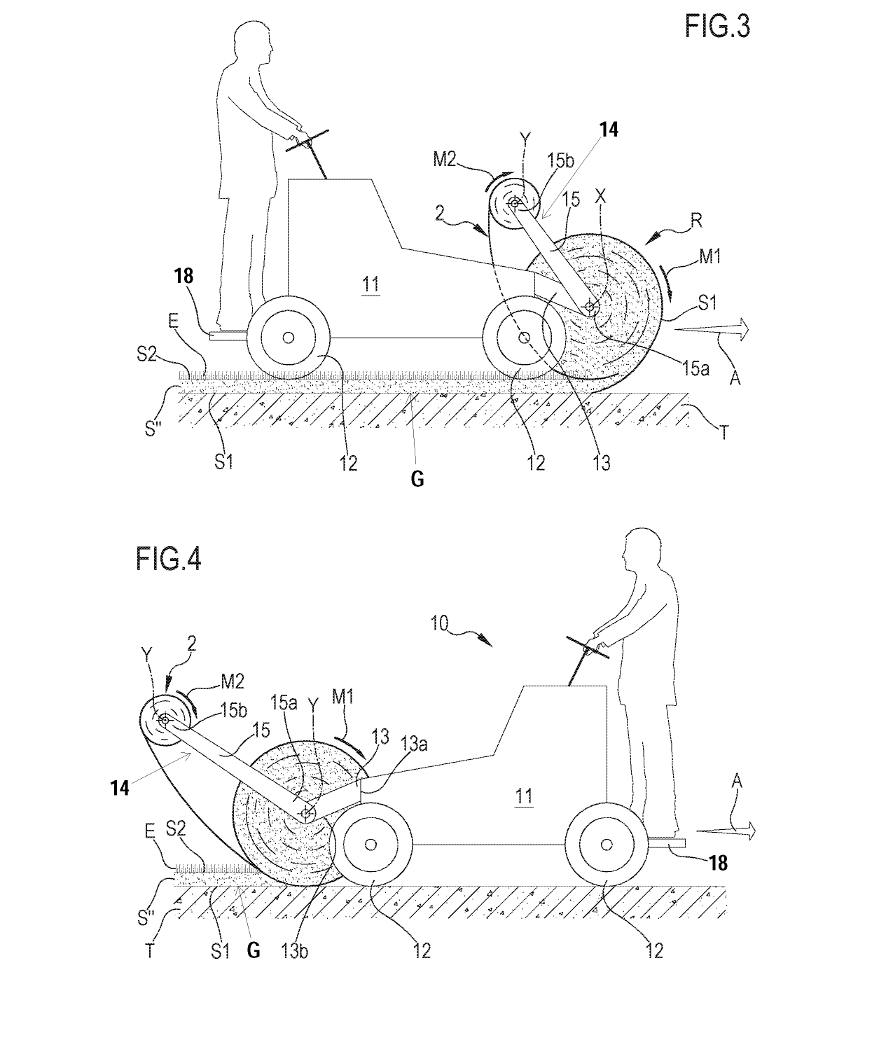

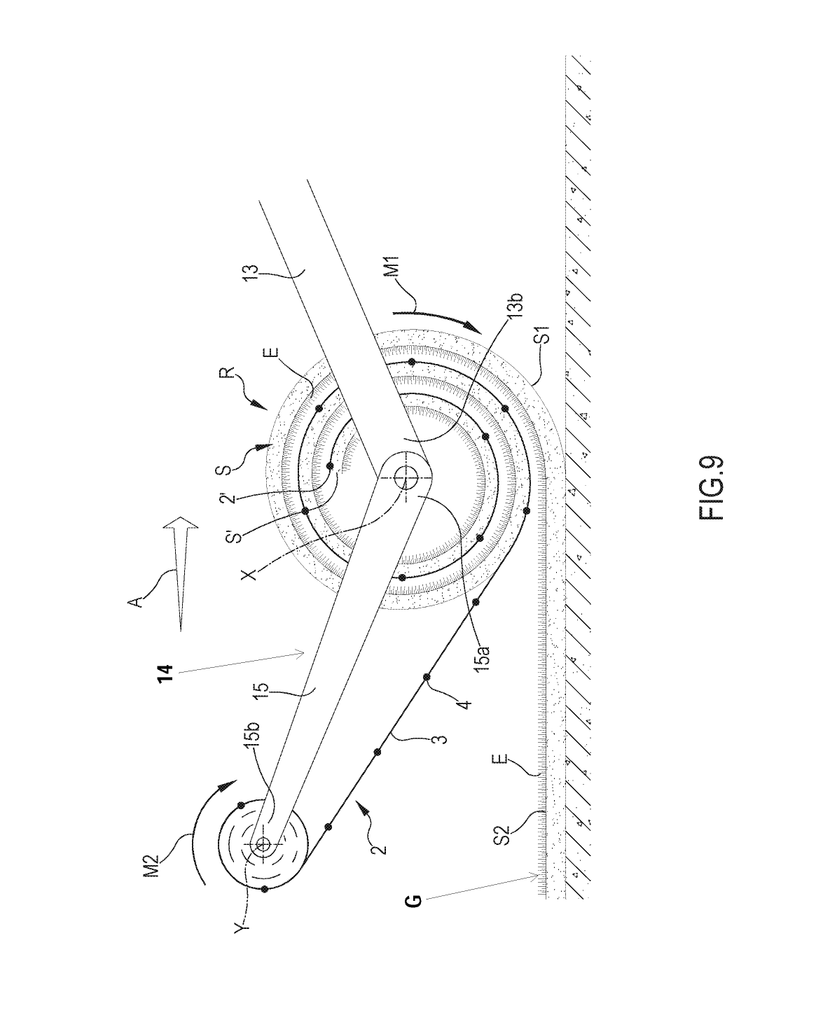

In detail, the soil layer S extends in thickness between a first surface S1, configured to be laid in direct contact with the ground T in a laid condition of the soil layer S, and a second surface S2 from which emerges the grass E. In fact, the soil layer S following the unwinding of roll R and then when in contact with soil T is configured to define a turf G as shown in FIGS. 3, 4 and 9. Quantitatively, the thickness of the soil layer S can be greater than 0.5 cm, optionally is between 0.65 cm and 20 cm, even more optionally between 5 cm and 15 cm.

As shown in the attached figures, the soil layer S of the roll R, in the fully wound condition of the roll R, is wound around an axis (X) between an inner terminal flap S’ and an outer terminal flap S” defining a plurality of windings. In particular, the soil layer S is wound in such a way that the grass E emerging from the second surface S2 is substantially facing the center of the roll, in particular, axis (X). In detail, as visible from the attached figures, considering the single winding of the soil layer the first surface S1 of the soil layer S is facing the outside of the roll R whereas the second surface from which emerges the grass E is facing substantially the center of the roll. In this way, following the unwinding of the roll, the first surface S1 results directly facing and in contact with the ground T whereas the second surface S2 from which the grass E emerges is substantially distanced from the ground T: the grass E emerges on the opposite side of the ground T.

The roll R can comprise a number of windings of the soil layer S greater than 10, between 10 and 50, optionally between 12 and 30. In fact, the number of windings is determined by the length of the soil layer S; such length, measured along the windings or in a fully unwound condition of the layer S, can be higher than 20 m, optionally between 25 m and 50 m, even more optionally between 30 m and 45 m. In fact, the length of the soil layer S is defined by the maximum distance present between the inner terminal flap S' and the outer terminal flap S'' in the fully unwound condition of soil layer S on an ideal plane.

The soil layer S has furthermore a preset width, measured, in fully wound condition of the roll, along the axis (X). The width of the soil layer S defined furthermore the width of the roll R that can be greater than 0.25 m, optionally between 0.3 m and 1.8 m, even more optionally between 0.3 m and 1.5 m.

In fact, the roll R extends substantially along the axis (X) between a first and a second head portion: the maximum distance present between said first and second head portion defines substantially a width of the roll R, coinciding substantially with the width of the soil layer.

As visible for example from FIGS. 2, 5 and 6, the soil layer S, in the fully wound condition of the roll R, has an outer winding that extends starting from the outer terminal flap S” until at a tract until at the outer terminal flap S” of the soil layer itself. In fact, the outer winding of the soil layer represents the layer part that substantially defines an outer lateral surface of the roll R, having substantially cylindrical conformation.

In fact, the outer winding of the soil layer defines the maximum diameter of the roll R which can be greater than 50 cm, optionally between 60 cm and 200 cm, even more optionally between 70 cm and 150 cm.

The inner winding of the roll R delimits a seat 9 that extends along the axis X for the entire width of the roll R. In fact, the inner winding of the soil layer S delimits an inner lateral surface of the roll R which delimits said seat 9. The inner lateral surface of the roll R has a substantially cylindrical shape the diameter thereof, according to a plane orthogonal to the axis X, is between 50 mm and 250 mm, optionally between 60 and 220 mm. The seat 9 is configured to receive a roll around which is wound the soil layer S and the reticular structure 2. The roll may be of a hollow type to receive in engagement a lifter pin and be arranged substantially in line with the first and second head portion of the roll. Alternatively, the roll can protrude from the first and second head portion of the roll R in such a way that it can be engaged to allow the lifting of the roll. In both alternatives, the roll can be configured to define a component engageable to roll R and configured to

engage a lifter capable of allowing the lifting of the roll with respect to the ground,

allow the thrust of the roll along an advancement direction A and then the unwinding of it to the ground T.

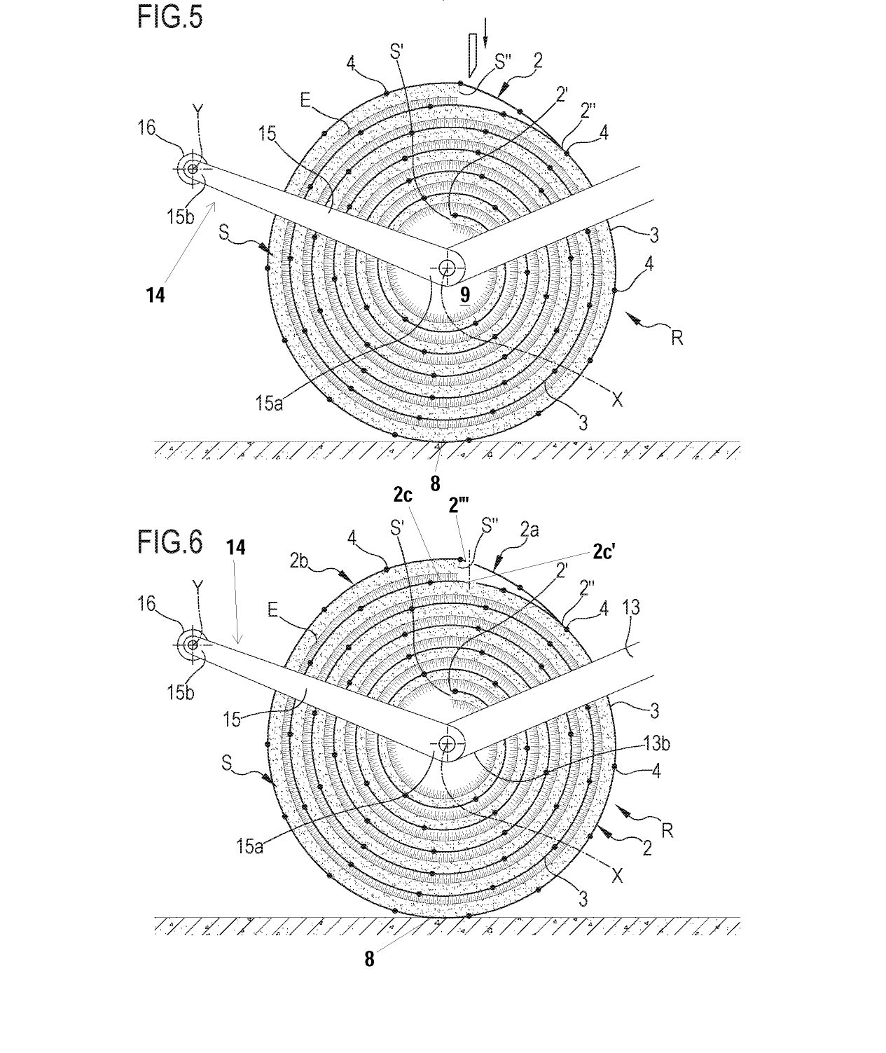

As above mentioned, the roll R comprises furthermore a reticular structure 2 wound too around the axis X between a respective inner terminal flap 2’ and an outer terminal flap 2” defining a respective plurality of windings at least partly interposed among the windings of the soil layer S. In detail, the reticular structure 2, at least in a fully wound condition of the roll R, comprises an outer winding that entirely covers the outer winding of the soil layer S. In fact, the outer terminal flap 2” of the reticular structure 2, at least in a fully wound condition of the roll R, is distance from the outer terminal flap S” if the soil layer S. In other words and as visible for example from FIGS. 2 and 5, the outer terminal flap 2” of the reticular structure 2 at least in a fully wound condition of the roll R, extends beyond the outer terminal flap S” of the soil layer S, with respect to a winding direction of the roll around the axis X. In fact, a part of the reticular structure 2 placed around the outer winding of the soil layer S is superimposed and substantially engaged to keep the wound soil layer, impeding undesired falls (releases) of the outer winding of the soil layer S. In greater detail still the braided shape of the elements of the reticular structure 2 define substantially gripping elements that substantially allow the engagement of portions of the reticular structure 2 overlapping.

On the other hand, with regard to the inner terminal flap 2’ of the reticular structure 2 this can be substantially laid at the inner terminal flap of the soil layer as shown in FIGS. 2, 5-7.

A preponderant part of the reticular structure 2 is interposed between the first surface S1 of a first winding of a soil layer and the second surface S2 of a second winding, outside from the first, of the soil layer S. The reticular structure 2 that defines the outer winding is in direct contact uniquely with at least part of the first surface S1 of the outer winding of the soil layer S.

The reticular structure 2 defines then a number of windings equal to or greater than the windings of the soil layer S, i.e. greater than 10, between 10 and 50, optionally between 12 and 30. In fact, the number of windings is determined by the length of the reticular structure 2 that substantially equal to the length of the soil layer; such length, measured along the windings of the reticular structure 2 or in a fully unwound condition of the structure 2, can be higher than 20 m, optionally between 25 m and 50 m, even more optionally between 30 m and 45 m. Also with regard to the reticular structure 2, the length is defined by the maximum distance present between the inner terminal flap 2' and the outer terminal flap 2'' in the fully unwound condition of reticular structure 2 on an ideal plane.

The reticular structure has furthermore a preset width, measured, in fully wound condition of the roll, along the axis X. The width of the reticular structure is substantially equal to the width of the soil layer, i.e. greater than 0.25 m, optionally between 0.3 m and 1.8 m, even more optionally between 0.3 m and 1.5 m.

The outer winding of the reticular structure 2 is in close contact with the first surface S1 of the soil layer S and defines then, with said soil layer S, the outer lateral surface of the roll R, having substantially cylindrical conformation.

The reticular structure 2 can, in a non-limiting extent, be realized in plastic material and have a monolithic structure. As above-mentioned, the reticular structure 2 is used for consolidating and reinforcing the soil layer S of the roll both in the step of transporting the roll and in the step of its unwinding, for example for preventing that the soil layer S can break, during a step of unwinding, thus compromising the installation of the soil layer for the realization of a turf G.

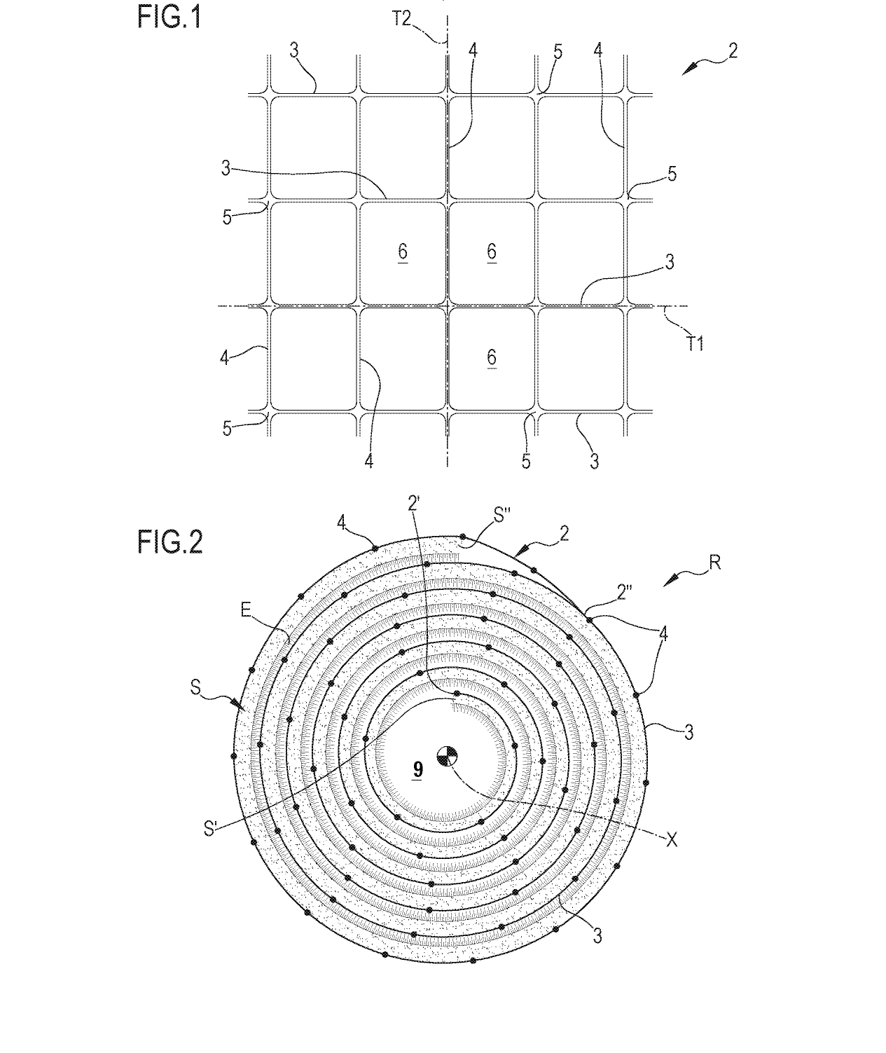

In the condition of a plastic monolithic reticular structure 2, it comprises a plurality of first elements (3) distanced from each other and having an elongated conformation according to a first trajectory T1; the first elements 3 are interconnected to a plurality of second elements 4 too distanced from each other and having an elongated conformation according to a transversal second trajectory T2, optionally orthogonal to the first trajectory T1; the first and the second elements 3, 4 intersect at knots 5 to form meshes 6. In FIG. 1 it is shown a detail of a portion of monolithic reticular structure wherein are visible the first and the second elements braided at knots.

The reticular structure 2 can be realized at least partly in plastic material, for example can be obtained by means of extrusion of at least one of the following materials: polypropylene, polyethylene, polyester, or a mixture of two or more of said materials.

The reticular structure 2 has, in a fully unwound condition, a substantially rectangular shape which extends between the inner and the outer terminal flap; in other words, the reticular structure 2 in fully unwound condition defines essentially an elongated strip. The reticular structure 2 is wound around the axis X together with the soil layer S to define the roll R.

The reticular structure 2 extends in thickness essentially between a lower surface and an upper surface; for example, the average thickness of the reticular structure 2 can be lower than 3 mm, optionally between 0,1 and 1,5 mm.

In particular, each one of the first elements 3 extends along the entire reticular structure 2 and is formed by a plurality of portions aligned along a same line. Analogously, each of said second elements 4 extends too along the entire reticular structure 2 transversally to the first elements 3 and is formed by a plurality of portions aligned along a same line: each of the first elements 3 is intersected by a plurality of second elements 4 and each one of the second elements 4 is intersected by a plurality of first elements 3 at knots 5 to form meshes 6. The reticular structure 2 defines a monolithic grid (net), i.e. in a single piece, exclusively constituted by said first and second elements 3, 4.

In detail, the first elements 3 have an elongated conformation according to a first trajectory T1 (FIG. 1). The trajectories T1 of the first elements 3 are substantially parallel to each other. In particular, the first elements 3 of the reticular structure are distanced from each other with respect to a direction parallel to the axis X: in particular, the distance between two first elements 3 immediately consecutive with respect to the axis X is between 15 and 70 mm, optionally between 20 and 50 mm.

The first elements 3 extend along the plurality of windings of the reticular structure 2; each first element 3 extends in length along the full length extension in length of the reticular structure 2, optionally said length extension is measured along the windings, even more optionally along a plane orthogonal to the axis X of the reticular structure 2. In fact, the length of each first element 3 coincides substantially with the length of the reticular structure 2, i.e. each first element 3 extends in length between the inner terminal flap 2’ and the outer terminal flap 2”. Each first element 3 extend along the plurality of windings of the reticular structure 2 and can have a length greater than 20 m, optionally between 25 m and 50 m, even more optionally between 30 m and 45 m.

The first elements 3 can have, at least at a centerline portion defined between two immediately consecutive knots 5 and orthogonally to the first trajectory T1, a section having substantially elliptical or circular shape. It is not excluded the possibility of realizing first elements 3 having, at least at a centerline portion defined between two immediately consecutive knots 5 and orthogonally to the second trajectory, a section having, for example, rectangular, square, circular, or “T” shape. The first elements 3 have a substantially threadlike structure and have then along their development a reduced transversal section; for example, the first elements 3 may have a transversal section, measured at a centerline portion defined between two immediately consecutive knots, of area lower than 5 mm², optionally between 0,1 mm² and 1,5 mm². The transversal section remains substantially constant for the entire development of the first element 3 with an increase in section at the knots where the first element extends to join with said second elements 4.

Also the second elements 4 have an elongated conformation according to a second trajectory T2. As visible in the attached figures, the trajectories T2 of second elements 4 are parallel to each other. The second trajectories T2 can be rectilinear in such a way as to form straight and elongated second elements along parallel directions. In fact, the second trajectory T2 of the second elements 4 is substantially rectilinear and parallel to the axis X: the second trajectory of each second element 4 is substantially orthogonal to the first trajectory T1 of the first elements 3.

Each second element 4 extends in length along the second trajectory T2 for the entire width of roll R. In fact, each second element 4 extends in length between the first and second head portion of the roll R. Quantitatively, each second element 4 has a length greater than 0.25 m, optionally between 0.3 m and 1.8 m, even more optionally between 0.3 m and 1.5 m. The second elements 4 are also distanced from each other: The two second elements 4 immediately consecutive along the windings are placed at a minimum distance between 12 and 50 mm, optionally between 15 and 40 mm.

The second elements 4 can have, at least at a centerline portion defined between two immediately consecutive knots 5 and orthogonally to the second trajectory T2, a section having substantially elliptical or circular shape. It is not excluded the possibility of realizing second elements 4 having, at least at a centerline portion defined between two immediately consecutive knots 5 and orthogonally to the second trajectory, a section having, for example, rectangular, square, circular, or “T” shape.

The second elements 4 have a substantially threadlike structure and have then along their development a reduced transversal section; for example, the second elements 4 may have a transversal section, measured at a centerline portion defined between two immediately consecutive knots 5, of area lower than 5 mm², optionally between 0,1 mm² and 1,5 mm². The transversal section can remain substantially constant for the entire development of the second element 4 with an increase in section at the knots 5 where the second element extends to join with said first elements 3.

The ratio between the distance between the two adjacent first elements 3 and the distance between two adjacent second elements 4 is between 0.5 and 2, optionally between 0.5 and 1.8. The meshes 6 of the reticular structure 2 are substantially square. It is not excluded the possibility of realizing meshes having different shape, for example rectangular, triangular or rhomboidal. As the distances between first and second elements vary, the size of meshes 6 varies, which may have a through-area between 200 mm² and 3000 mm², optionally between 250 mm² and 2000 mm².

The reticular structure 2 can be stretched along at least one direction of extension of the first elements 3 and/or second elements 4 to define a mono-stretched and/or bi-stretched reticular structure 2; for example, the reticular structure 2 can be stretched along the development of only the first elements 3, i.e., along the first trajectory T1. The reticular structure 2 can be stretched along two directions, in particular along the development of the first and second elements 3, 4 to define a bi-stretched reticular structure as shown, for example, in FIG. 1: in such a configuration the reticular structure results stretched both along the first trajectory T1 and along the second trajectory T2. The stretching ratio, i.e., the ratio between the length of the elements (first elements and/or second elements) after the stretching and their length before the stretching is greater than 1.5. In detail, the first elements 3 are stretched along the first trajectory T1; the first elements 3 have a stretching ratio greater than 1.5, optionally between 2 and 8, more optionally between 2,5 and 4. The second elements 4 are stretched along the second trajectory T2; the second elements 4 have a stretching ratio greater than 1.5, optionally between 2 and 5, more optionally between 2 and 4. The threadlike structure of the first and second elements 3, 4 is substantially defined by the stretching action, which accentuates the elongation of said elements and thins their transversal section. The specific weight of the reticular structure 2 is between 5 g/m² and 15 g/m², optionally between 6 g/m² and 12 g/m².

The reticular structure 2 has a specific tensile resistance, along the first and/or second elements equal to or greater than 0.3 kN/m, in particular between 0.5 kN/m and 5 kN/m, even more optionally between 1 kN/m and 2 kN/m; said specific tensile resistance is measured using the method given in ASTM D7179.

The monolithic reticular structure 2 in plastic material can be realized by means of a pulsed head or counter-rotating head extrusion process. For example, the reticular structure 2 can be substantially realized with the process according to the description in the patent application WO 2022/243798 A1 from page 19, line 20, to page 21, line 21. Alternatively, the reticular structure 2 can be substantially realized using, in principle, the extrusion process according to the description in the Italian patent application No. 102023000013959 from page 22, line 29, to page 25, line 9. Of course, it is not excluded the possibility of using different extrusion parameters in accordance with the material and shape of the reticular structure to be realized.

It is also not excluded the possibility of realizing the reticular structure 2 by punching a plane sheet of plastic material.

The reticular structure 2 may alternatively comprise a braided wire mesh, for example made of metal material, or of nonwoven fabric.

### Turf laying process

It is object of the present invention a turf laying process. The process comprises a step of arranging a roll R of the type described above.

The process may provide for an initial step of preparing the soil on which the turf is to be installed. Then, the process may provide for taking out at least one roll and its movement to an installation area. The movement of the roll may take place by lifting and moving the roll (for example, by means of special equipment that allows to engage the engaged roll in the seat 9 of the roll R) or by rolling it. In the case of movement by rolling, the roll R may be according to its winding direction.

The process provides for the positioning of the roll R in such a way that the outer terminal flap of the soil layer S is distanced from the soil. In particular, as shown in FIG. 5 and 6, the roll R has a leaning area 8 facing the ground (optionally in contact with the ground), defined before a step of unwinding of the roll. The outer terminal flap S'’ of the soil layer S is distanced from said leaning area 8, in particular counterposed to the leaning area 8. In this way, the outer terminal flap S” of the soil layer S is substantially counterposed to the ground T in such a way to be accessible by the user.

After having properly placed the roll on the ground, the process essentially comprises a step of unwinding the roll R on the ground in such a way that the first surface S1 of the soil layer S is in contact with the ground T and, at least during the unwinding phase of the roll R, taking out at least part of the reticular structure 2. The step of taking out the reticular structure 2 allows to eliminate the reticular structure 2 during the definition of turf G so as to prevent pollution of the environment.

As above described, the soil layer is wound by the outer winding of the reticular structure 2 that allows to keep the roll substantially in its fully wound configuration.

The process can then comprise a step of removal of the outer layer for facilitating the unwinding of the soil layer. For example, the process can comprise a cutting step of the outer winding and the immediately underlying winding of the reticular structure 2 at a tract located between the outer terminal flap S'’ of the soil layer S and the outer terminal flap 2'' of the reticular structure 2 (see for example FIGS. 5 and 6). This cutting step can be carried out manually by a user with a kind of knife configured to cut into the reticular structure along its entire width; alternatively, this step can be carried out by a cutting device carried by a special equipment.

As shown in FIG. 6, the cutting step defines:

on the outer winding of the reticular structure 2, an intermediate longitudinal flap 2'' arranged between the outer terminal flap S'' of the soil layer S and the outer terminal flap 2'’ of the reticular structure 2, wherein the outer winding of the reticular structure 2, following the cutting step, has a first sector 2a comprising the outer terminal flap 2'' and a second sector 2b comprising the intermediate flap 2'',

on the winding of the reticular structure 2 immediately underlying the outer winding, a terminal gripping flap 2c'.

In fact, the first sector 2a in the condition of a roll laid on the ground, is defined by the tract of reticular structure comprising the outer terminal flap 2'' and extending to the leaning area 8. The second sector 2b, on the other hand, extends in the grounded roll condition between the intermediate flap 2'' and the leaning area 8 (see FIG. 6 for example).

Following the cutting, it is optionally possible to remove at least the outer winding of the reticular structure 2. Thus, the cutting step of the reticular structure 2 can be carried out with the roll R resting on the ground; of course, it is not excluded the possibility of carrying out the cutting of the reticular structure and in addition the removal of the outer winding of the reticular structure 2 in the condition of the roll raised from with respect to the ground.

In particular, the process, after the cutting step and then once released the outer terminal flap S” of the soil layer, comprises the following steps:

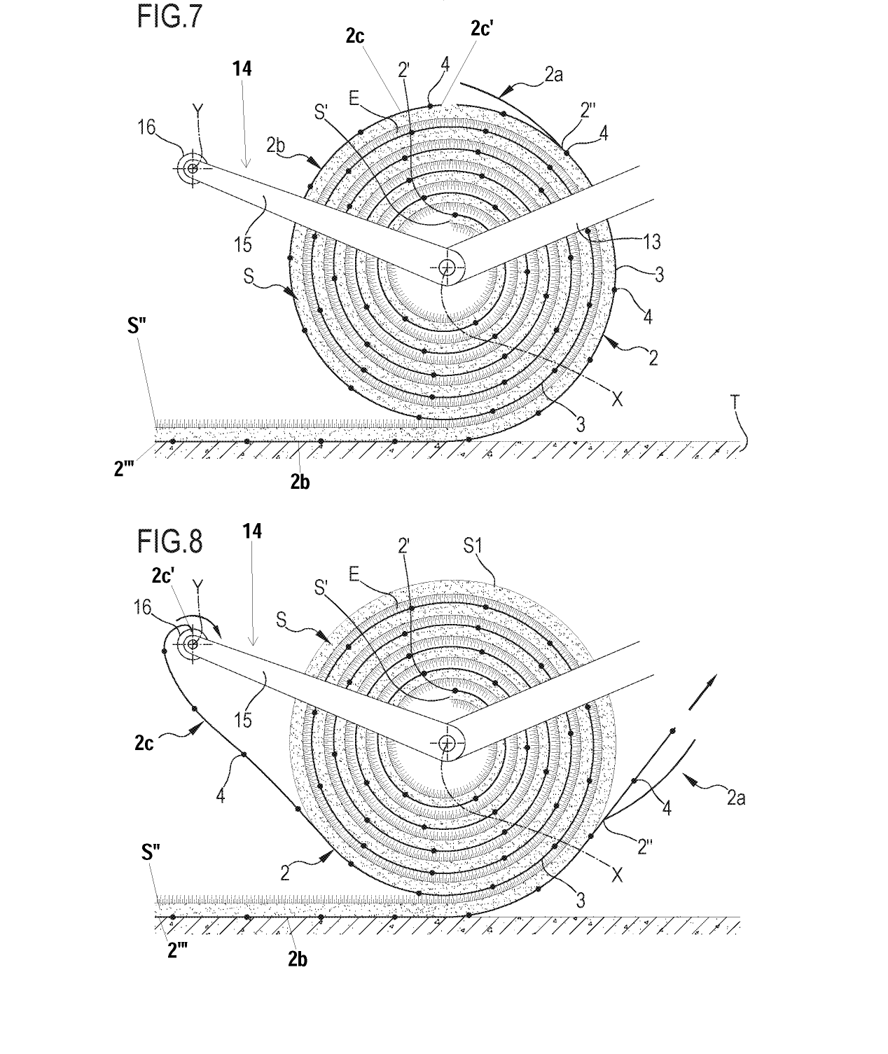

lay at least one tract of the soil layer S on the ground T comprising the outer terminal flap S'' of the soil layer S together with the second sector 2b of the outer winding of the reticular structure 2 (see for example the schematic representation of FIG. 7), optionally interposed between the soil T and said soil layer S laid on the ground,

take out (i.e. remove) the outer winding of the reticular structure 2, for example by extracting the reticular structure 2 present between the soil layer S and the ground T as schematically shown in FIG. 8.

Following the removal of the outer winding of the reticular structure 2, the process comprises a step of moving at least part of the roll R along an advancement direction A to unwind said roll R, and in particular, the soil layer S with the remaining reticular structure 2. In particular, the step of moving the roll provides for distancing the outer terminal flap S” of the soil layer S from the inner terminal flap S’ of the soil layer S itself.

The step of unwinding the roll takes place around the axis X that results then to be an axis of winding and unwinding the soil layer S and the reticular structure 2. The axis X during the step of unwinding the roll R moves along the advancement direction A and approaching the ground T because of the reduction of the diameter of the roll R due to the unwinding action.

The inner terminal flapS’ of the soil layer S, at least during the step of unwinding the roll R moves away from the outer terminal flapS'' of the same soil layer S (optionally placed on the ground) which results instead substantially fixed to the ground T.

The step of taking out the reticular structure 2 during the step of unwinding the roll R, comprises a step of winding the reticular structure 2 around a respective collecting axis Y, distinct and distanced from the axis X of the roll R. The collecting axis Y of the reticular structure 2 is laid upwards of the axis X of the roll R with respect to the advancement direction A. The collecting axis Y can be fixed with respect to the axis X i.e. Keep a prefixed distance from said axis X. Alternatively, the collecting axis Y can be movable with respect to the axis X of the roll R, approaching and moving away. As schematized in the attached figures, the collecting axis Y is substantially parallel to the axis X of the roll R.

The step of winding the reticular structure 2 around the collecting axis Y can comprise a winding of the reticular structure 2 around a drum, optionally motorized.

The process, after the cutting step, comprises the following steps:

grasp the reticular structure 2 at the terminal gripping flap 2c’ of a winding 2c of the reticular structure (see for example FIG. 8) that, in fully wound condition of the roll R, results laid immediately consecutively to the outer winding of the reticular structure,

following the step of grasping the reticular structure 2 at the terminal gripping flap 2c’, move the roll along the advancement direction A to unwind the soil layer S on the ground and unwind the reticular structure 2,

during the step of unwinding the soil layer S and reticular structure 2, remove (in particular, wind) the reticular structure.

For example, the step of grasping the reticular structure 2 can comprise at least a step of engaging said winding drum structure 2, at the terminal gripping flap 2c’. In this condition, the step of taking out the reticular structure 2 can then comprise a step of winding said reticular structure 2 around the collecting axis Y, optionally around the drum.

The step of taking out the reticular structure 2, in particular, winding the reticular structure 2 is synchronized with the step of unwinding the soil layer S. In detail, the winding speed of the reticular structure 2 is proportional to at least one of the following parameters: a movement speed of the roll along the advancing direction, an angular speed of a point of the unwinding roll.

The step of winding the reticular structure 2 can be carried out on a same drum by unwinding two or more rolls R. In fact, reticular structures of different rolls R can be wound on a same drum and then following the unwinding on the ground T of two or more rolls. In order to carry out this operation, it will be necessary for an operator or a special tool at the end of unwinding a roll R to perform the winding invitation of the new reticular structure 2 around the drum.

### Equipment

It is also an object of the present invention an equipment 10 for laying turf G, in particular configured to carry out the above-described laying process for the realization of turf. The equipment 10 comprises a frame 11 and a movement system 12 supporting the frame 11 and configured to allow the movement of the equipment 10 on the ground along an advancement trajectory or direction A. For example, the movement system 12 may comprise at least one of: an axle carrying one or more wheels, a track system, at least one roll.

In the attached figures it is shown, in a non-limiting extent, an equipment 10 that defines a kind of user-operated vehicle. For example, the equipment 10 can comprise, in a non-limiting extent, a guiding system carried by the frame 11 and connected to the movement system 12, wherein the guiding system is configured to allow a user to operate the equipment 10. In detail, the guiding system can comprise a motor, a transmission system that connects the motor to the movement system 12, a maneuvering system connected to the motor and the transmission system; the maneuvering system is configured to allow a user to drive in the movement the equipment 10. In case the equipment 10 with an operator on board, the same may comprise a driving position 18 configured to receive at least one user, for example, a platform or a seat.

It is not excluded the possibility of providing a self-guided equipment.

The equipment 10 also comprises a support 13 carried by the frame 11 and configured to support at least one roll R of the type according to the above and allow it to be unwound to the ground S. In particular, the support 13, in use, is configured to engage the roll R and allow its movement along at least one advancing direction, during the movement of the equipment 10 to the ground.

The support 13 can further be configured to move the roll R approaching and moving away with respect to the ground T, for example along a substantially vertical direction. In particular, the support 13, in use, is configured to lift and lower the roll R. For example, the support 13 may be used to remove the roll R leaning on the ground T at a storage area, lift it and keep it raised during the movement of the equipment 10 from the storage area of the roll R to an installation/unwinding area of the roll R. At the installation area, the roll R can be lowered and rested on the ground T; in the condition of roll R resting on the ground, the advancement of equipment 10, allows to unwind the roll.

In detail, the support 13 may comprise at least one arm that is constrained to the frame 11 and extends longitudinally between a first and second end portions 13a, 13b; the arm of the support 13 is engaged to the frame 11 at the first end portion 13a for example by means of a hinge-type constraint to allow the lifting and lowering of the second end portion 13b with respect to the ground T.

In detail, the support 13 comprises an engagement portion configured to receive in engagement at least a roll R. The engagement portion is defined at the second end portion 13b and can comprise a roll configured to be inserted at least partly in the roll R. The roll is configured to rotate around its own axis to allow the rotation of the roll R engaged to said roll. The axis of the roll of the engagement portion, in use, is substantially horizontal and substantially parallel to the axis X.

In detail, the engagement portion, optionally the roll, is configured to be inserted in the seat 9 of the roll R, allow the thrust of the roll during the movement of the engagement and then its unwinding on the ground T. The engagement portion of the support 13 can alternatively comprise at least a hook configured to receive in engagement a roll inserted in the seat 9 of the roll; the roll can then be part of the roll R and not of the equipment 10.

The support can be uniquely movable approaching and moving away with respect to the ground. Alternatively, the engagement portion of the support 13 can be movable approaching and moving away with respect to the frame 11. The engagement portion can be then configured to

allow the rotation of the roll around the axis X, and

rotate around an axis arranged substantially at the frame 11 to allow the engagement portion to move in approach and moving away with respect to the ground T.

In fact, the at least a support arm 13 is of an extendable type, optionally to vary a distance between the first and second end portions 13a, 13b.

Additionally, the at least an arm can comprise a single arm or at least a first and a second arm distanced from each other and configured to receive in interposition at least a roll R.

As shown in the attached figures, the equipment 10 also comprises a collection device 14 configured to carry out the taking out of the reticular structure, at least during the unwinding of the roll R on the ground S. In detail, the collection device 14 is engaged to at least one between the frame 11 and the support 13 and configured to wind the reticular structure 2 around a collecting axis Y, in use, horizontal. In fact, the collecting axis Y is substantially parallel to the axis around which is movable by rotation the roll R or the roll of the engagement portion of the support 13. In the attached figures it has been shown, in a non-limiting extent, a collection device engaged to the support 13; it is obviously not excluded the possibility of providing for a collection device 14 engaged directly and uniquely to the frame 11.

The collection device 14 can comprise at least an arm 15 that extends longitudinally between a first and a second end portion 15a, 15b; the arm 15 of the collection device 14 can be then engaged to the frame 11 and/or to the support 13 at the first end portion 15a, for example by means of hinge-type constraint in such a way that the arm 15 can approach and move away with respect to the support 13.

The collection device 14 comprises a respective engagement portion 16 configured to receive in engagement (optionally in winding) the reticular structure 2 in unwinding from the roll R. The engagement portion is defined at the second end portion 15b of the arm 15 of the collection device 14 and can comprise, for example, at least a drum. The drum is configured to rotate around its own axis, optionally to allow the winding of the reticular structure 2 around the drum itself. In detail, the axis of the drum of the engagement portion 16 coincides with the collecting axis Y, optionally substantially parallel to the axis X of the roll when carried by the equipment 10.

The engagement portion 16 optionally the drum can be additionally movable approaching and moving away with respect to the frame 11. For example, the at least an arm 15 of the collection device 14 can be of an extendable type, optionally to vary a distance between the first and second end portions 15a, 15b.

Also the at least an arm 15 of the collection device 14 can comprise a single arm or can comprise at least a first and a second arm distanced from each other. The first and the second arm of the collection device 14 are configured to engage the drum of the engagement portion 16 at the second end portion 15b and allow its rotation around its own axis, i.e. the collecting axis Y of the reticular structure 2.

In an embodiment shown in FIG. 4, the support 13 can be interposed between the frame 11 and the engagement portion 16 of the collection device 14. Alternatively, as shown in FIG. 3, the collection device 14 can be laid above the frame 11 and above the support. In fact, the collection device 14 (optionally at least the collecting axis Y) is laid upwards of the support 13 (optionally of the axis X of the roll R supported by the equipment 10), with respect to the advancement direction A of the equipment 10.

Additionally, the drum of the collection device 14, in use, is laid at a first distance from the ground, wherein the second end portion 13b of the support, in use, is laid at a second distance from the ground lower than the first distance; for example, the ratio between the first distance and the second distance is greater than 1.2, optionally between 1.5 and 3.

The drum of the engagement portion 16 of the collection device 14 can be of the motorized type. For example, the collection device 14 can comprise at least an actuator active on the drum and configured to allow the rotation of the drum itself around its own axis, optionally the collecting axis Y. For example, the actuator comprises at least an electric motor active on the drum. In this way, the drum can actively wind the reticular structure 2 in unwinding from the roll R and the stretching of the soil layer S to the ground T.

The equipment 10 can also comprise a control unit active in command on the actuator and configured to command a rotation of the drum of the collection device 14. The equipment 10 can also comprise at least a sensor connected to the control unit; the sensor is configured to emit a signal representative of at least a rotation parameter of the roll carried by the equipment. The control unit can be then configured to:

receive at least one signal from the sensor,

in accordance with the received signal, estimate a value of the rotation parameter,

in accordance with the estimated value of the rotation parameter, command the activation of the actuator to determine a rotation of the drum of the collection device 14.

The control unit is then configured to command the activation of the actuator to adjust the rotation speed of the drum in accordance with the estimated value of the rotation parameter of the roll R carried by the equipment. In detail, the rotation parameter can comprise at least one of: an angular speed of the roll of the support, a rotation speed of the roll, a rotation speed of a point defined on the outer surface of a roll engaged to the roll.

In fact, the control unit is configured to synchronize the rotation of the drum of the collection device 14 with a rotation of a roll R carried by the equipment, optionally in unwinding around the roll of the support 13.

The present invention involves, with respect to state-of-the-art solutions, considerable advantages. In particular, the possibility of taking out the reticular structure 2 at least during the turf laying step S allows the use of low-cost and high-strength reticular structures without adversely impacting the environment and allowing an effective laying of the soil layer on the ground. Additionally, the ability of taking up the reticular structure allows its use for the winding of soil layers to realize additional rolls.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or "comprising" do not exclude other elements or steps, the terms "a" or "one" do not exclude a plural number, and the term “or” means either or both, unless the disclosure states otherwise. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for laying turf by unwinding a roll on a ground, wherein the roll comprises:
a soil layer extending between a first surface and a second surface, the soil layer having grass emerging from the second surface, the soil layer wound in a roll around an axis between an inner terminal flap of the soil layer and an outer terminal flap of the soil layer to define a plurality of windings of the soil layer, wherein the grass emerging from the second surface of the soil layer is substantially facing said axis, and
a reticular structure wound around the axis between a respective inner terminal flap of the reticular structure and a respective outer terminal flap of the structure defining a respective plurality of windings of the reticular structure at least partly interposed between the windings of the soil layer,
wherein the method comprises:
unwinding the roll on ground by bringing the first surface of the soil layer in contact with the ground, and
during the unwinding of the roll, removing at least part of the reticular structure.

2. The method according to claim 1, wherein the unwinding the roll includes:
placing the roll on the ground,
laying on the ground a tract of the soil layer comprising the outer terminal flap of said soil layer, and
moving at least part of the roll along an advancement direction along the ground to unwind said roll.

3. The method according to claim 2, wherein the moving the at least part of the roll along an advancement direction includes distancing the outer terminal flap of the soil layer from the inner terminal flap of the same soil layer.

4. The method according to claim 1, wherein the step of unwinding the roll takes place around the axis of the soil layer and of the reticular structure and wherein the axis during the step of unwinding the roll moves along an advancement direction and approaching the ground.

5. The method according to claim 1, wherein the inner terminal flap of the soil layer, at least during the step of unwinding the roll moves away from the outer terminal flap of the same soil layer placed on the ground.

6. The method according to claim 1, wherein the outer terminal flap of the soil layer, during the unwinding of the roll, remains stationary with respect to the ground.

7. The method according to claim 1, wherein the soil layer, at least in a fully wound condition of the roll, has an outer winding that defines at least part of an outer surface of the roll.

8. The method according to claim 7, wherein the step of unwinding the roll comprises a step of initial unwinding that includes:
unwinding at least a part of the outer winding of the roll in such a way that the outer longitudinal flap of the soil layer is laid on the ground,
contacting at least a part of an outer winding of the reticular structure;
moving said roll along the advancement direction to allow an unwinding of the soil layer on the ground and of the reticular structure, and
at least during the step of moving the roll, progressively withdraw the reticular structure unwinding from the roll.

9. The method according to claim 1, wherein the step of taking out at least part of the reticular structure during the step of unwinding the roll comprises a step of winding the reticular structure around a respective collecting axis.

10. The method according to claim 9, wherein the collecting axis is distinct and distanced from the axis of the roll, is arranged upwards of the axis of the roll with respect to the advancement direction and is movable with respect to the axis of the roll.

11. The method according to claim 9, wherein the collecting axis is movable approaching and moving away with respect to the axis of the roll and is substantially parallel to the axis of the roll.

12. The method according to claim 9, wherein the step of winding the reticular structure around the collecting axis comprises a winding of the reticular structure around a drum with manual or motorized winding.

13. The method according to claim 1, wherein the reticular structure, at least in a completely wound condition of the roll, comprises an outer winding that entirely covers the outer winding of the soil layer.

14. The method according to claim 1, wherein the outer terminal flap of the reticular structure, at least in a completely wound condition of the roll, is distanced from the outer terminal flap of the soil layer, and wherein the outer terminal flap of the reticular structure, at least in a completely wound condition of the roll extends beyond the outer terminal flap of the soil layer, with respect to a winding direction of the roll around the axis.

15. The method according to claim 13, comprising a cutting step of the outer winding and the immediately underlying winding of the reticular structure at a tract located between the outer terminal flap of the soil layer and the outer terminal flap of the reticular structure, wherein said cutting step of the reticular structure defines:
on the outer winding, an intermediate longitudinal flap arranged between the outer terminal flap of the soil layer and the outer terminal flap of the reticular structure, wherein the outer winding of the reticular structure, following the cutting step, has a first sector comprising the outer terminal flap and a second sector comprising the intermediate flap,
on the winding of the reticular structure immediately underlying the outer winding, a terminal gripping flap.

16. The method according to claim 15, wherein, after the cutting step, the method further comprises:
laying a tract of the soil layer on the ground comprising the outer terminal flap of the soil layer together with the second sector of the outer winding of the reticular structure, interposed between the soil and said soil layer laid on the ground, and
removing the outer winding of the reticular structure.

17. The method according to claim 15, wherein, after the cutting step, the method further comprises
grasping the reticular structure at the terminal gripping flap,
following the step of grasping the reticular structure at the terminal gripping flap, moving the roll along the advancement direction to unwind the soil layer on the ground and unwind the reticular structure,
during the step of unwinding the soil layer and reticular structure, withdrawing the reticular structure;
wherein the step of grasping the reticular structure includes engaging said one winding drum structure, at the terminal gripping flap, and
wherein the step of taking out the reticular structure includes winding said reticular structure around a collecting axis, starting from a tract placed at the terminal gripping flap.

18. The method according to claim 15, wherein:
the outer terminal flap of the soil layer, before the step of cutting the reticular structure, is distanced from the leaning area, and
wherein the cutting of the reticular structure is carried out along a whole width of the reticular structure.

19. The method according to claim 1, wherein:
the roll, before the step of unwinding, has a leaning zone in contact with the ground, wherein the outer terminal flap of the soil layer, before the step of unwinding of the roll, is distanced from said leaning area; and
wherein the outer terminal flap of the soil layer, before the step of unwinding of the roll, is substantially counterposed to the leaning area.

20. The method according to claim 1, further comprising:
before the step of laying at least a soil layer, a step of leaning the roll to the ground at the leaning area;
and wherein after the leaning of the roll to the ground, the process comprises the further steps of:
lay a tract of the soil layer on the ground comprising the outer terminal flap,
remove the outer winding of the reticular structure,
grasp the reticular structure at the terminal gripping flap,
following the step of grasping the reticular structure at the terminal gripping flap, move the roll along the advancement direction to unwind the soil layer on the ground and unwind the reticular structure, and
during the step of unwinding the soil layer and reticular structure, withdraw the reticular structure.
